(19) United States
(12) Patent Application Publication
(10) Pub. No.: US 2015/0351174 A1
(43) Pub. Date: Dec. 3, 2015

(54) DIMMING CIRCUIT FOR A PHASE-CUT TRIAC DIMMER

(71) Applicants: Timothy Chen, Aurora, OH (US); Haiyan Wang, Solon, OH (US)

(72) Inventors: Timothy Chen, Aurora, OH (US); Haiyan Wang, Solon, OH (US)

(73) Assignee: Technical Consumer Products, Inc., Aurora, OH (US)

(21) Appl. No.: 14/333,620

(22) Filed: Jul. 17, 2014

Related U.S. Application Data
(60) Provisional application No. 62/004,998, filed on May 30, 2014.

(51) Int. Cl. H05B 33/08

(52) U.S. Cl. CPC H05B 33/0815; H05B 33/0845; H05B 33/0896

(57) ABSTRACT

A dimmer circuit for at least one LED is disclosed. The LED is controlled by a TRIAC dimmer. A leakage current flows through the TRIAC dimmer if the TRIAC dimmer is off. The dimmer circuit include inputs for receiving a source of incoming AC power, a rectifier for receiving the source of incoming AC power and producing a DC voltage, a controller for receiving the DC voltage from the rectifier and providing a switching signal, a first circuit, and a loading circuit. The first circuit receives the switching signal from the controller. The first circuit includes a first switching element that is selectively activated based on the switching signal. The loading circuit receives the switching signal from the controller. The loading circuit includes a second switching element that is activated if the first switching element is deactivated. The loading circuit selectively provides a minimum loading current.

### RELATED APPLICATIONS

This application claims the benefit of U.S. Provisional Application No. 62/004,998, filed on May 30, 2014.

### TECHNICAL FIELD

The present disclosure relates generally to a dimming circuit for at least one light emitting diode (LED), and more particularly to a dimming circuit selectively providing a minimum loading current back to a TRIAC dimmer.

### BACKGROUND

Light emitting diode (LED) based lighting systems may offer several energy and reliability advantages over other types of lighting systems such as, for example, incandescent or fluorescent lighting. Thus, LED based lighting systems may be widely used to replace other existing lighting technologies. It should also be noted that dimming devices have also been developed that may be used to dynamically adjust the level of brightness in a lighting fixture. However, some types of dimming devices available today do not always work well with LED based lighting fixtures. For example, a phase-cut TRIAC dimmer is one commonly known and widely used dimming device. TRIAC dimmers were originally intended to handle the wattage induced by incandescent bulbs. In contrast, LED bulbs consume much less power than an incandescent bulb.

For an LED bulb to be dimmable, the bulb's power supply should interpret a variable phase angle output from the TRIAC and adjust the constant current drive to the LEDs accordingly. However, this may prove to be difficult while keeping the TRIAC working correctly, and may result in performance issues. For example, sometimes the LED bulb may flicker or blink as the dimming level is adjusted.

### SUMMARY

In one embodiment, a dimmer circuit for at least one LED is disclosed. The LED is controlled by a TRIAC dimmer. A leakage current flows through the TRIAC dimmer when the TRIAC dimmer is off. The dimmer circuit includes inputs for receiving a source of incoming AC power, a rectifier for receiving the source of incoming AC power and producing a DC voltage, a controller for receiving the DC voltage from the rectifier and providing a switching signal, a first circuit, and a loading circuit. The first circuit receives the switching signal from the controller. The first circuit includes a first switching element that is selectively activated based on the switching signal. The loading circuit receives the switching signal from the controller. The loading circuit includes a second switching element that is activated if the first switching element is deactivated. The loading circuit selectively provides a minimum loading current that substantially dissipates the leakage current flowing through the TRIAC dimmer if the second switching element is activated.

In another embodiment, a dimmer circuit for at least one LED is disclosed. The LED is controlled by a TRIAC dimmer. A leakage current flows through the TRIAC dimmer when the TRIAC dimmer is off. The dimmer circuit includes inputs for receiving a source of incoming AC power, a rectifier for receiving the source of incoming AC power and producing a DC voltage, a controller for receiving the DC voltage from the rectifier and providing a switching signal, a snubber circuit and a loading circuit. The snubber circuit receives the switching signal from the controller. The snubber circuit includes a first switching element and a snubber resistor, where the first switching element is selectively activated based on the switching signal. The loading circuit receives the switching signal from the controller. The loading circuit comprises a second switching element that is activated if the first switching element is deactivated, and a third switching element that inverts the switching signal before being sent to the second switching element. The loading circuit is configured to selectively provide a minimum loading current that substantially dissipates the leakage current flowing through the TRIAC dimmer if the second switching element is activated.

### BRIEF DESCRIPTION OF THE DRAWINGS

FIG. 1 is an exemplary block diagram of a driver circuit;

FIG. 2 is an illustration of an AC waveform being sent through a triode alternating current (TRIAC) dimmer shown in FIG. 1;

FIG. 3 is a circuit diagram of the driver circuit shown in FIG. 1; and

FIG. 4 is an illustration of a controller shown in FIG. 3.

### DETAILED DESCRIPTION

The following detailed description will illustrate the general principles of the invention, examples of which are additionally illustrated in the accompanying drawings. In the drawings, like reference numbers indicate identical or functionally similar elements.

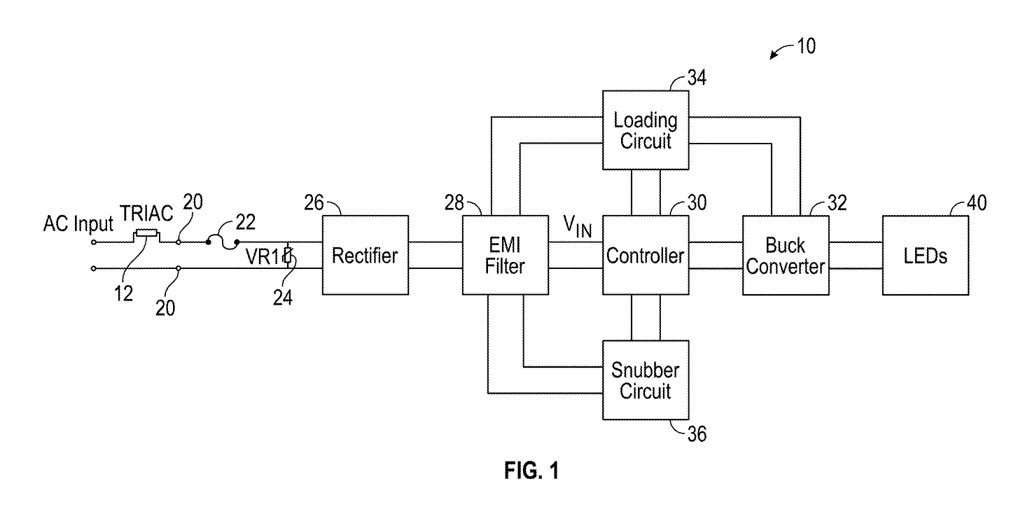

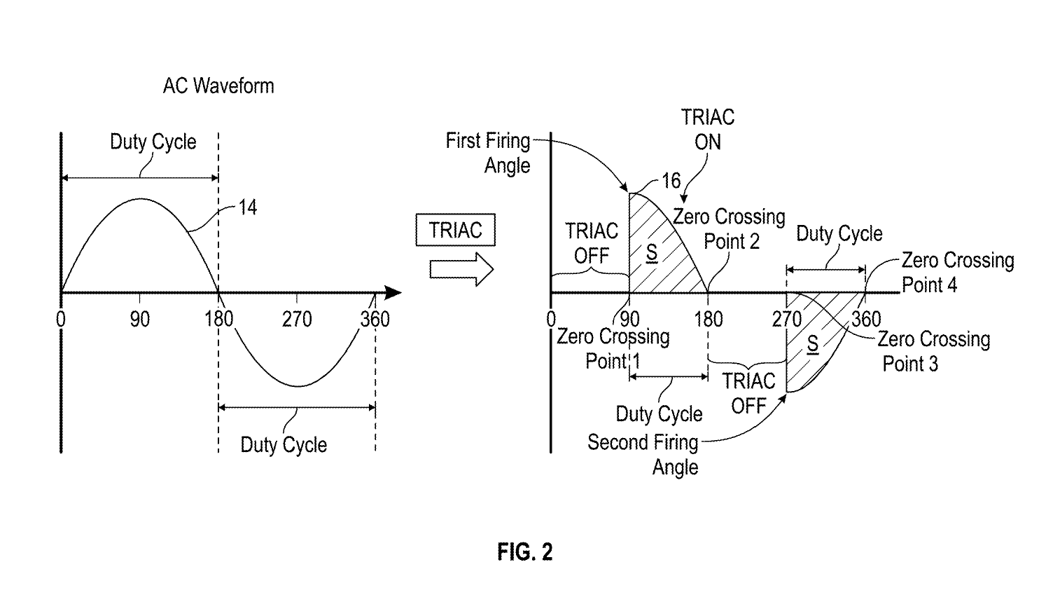

FIG. 1 is an exemplary block diagram of a dimming circuit 10 that may be used with a phase cut TRIAC dimmer 12. In one non-limiting embodiment, the dimming circuit 10 may be used to provide power to one or more light emitting diodes (LEDs). In an embodiment, the LEDs 40 may be organic LEDs (OLEDs). The TRIAC dimmer 12 may be electrically connected to a source (not shown) of AC power such as, for example, main power lines at a nominal 120 volts AC. The TRIAC dimmer 12 may be used to cut out or chop a portion of the AC power, allowing only a portion of the supplied power to pass to the dimming circuit 10. For example, FIG. 2 illustrates an exemplary standard AC voltage waveform 14. The TRIAC dimmer 12 is configured to output waveform 16, which is a chopped up version of the standard AC voltage waveform 14. Specifically, the TRIAC dimmer 12 may be used to adjust a duty cycle of the standard AC voltage waveform 14.

Continuing to refer to FIG. 2, the TRIAC dimmer 12 is on or activated if the waveform 16 is either above or below a zero-crossing. Specifically, the shaded regions S bounded by the waveform 16 represent when the TRIAC dimmer 12 is activated. Similarly, the TRIAC dimmer 12 is off if the waveform 16 is at zero-crossing. The exemplary waveform 16 as shown in FIG. 2 includes four zero-crossing points which are labelled as zero-crossing point 1, zero-crossing point 2, zero-crossing point 3, and zero-crossing point 4. The exemplary waveform 16 also includes two firing angles. Specifically, a first firing angle has a phase angle between about zero to one hundred and eighty degrees and a second firing angle has a phase angle between about one hundred and eighty and three hundred and sixty degrees. The firing angle of a TRIAC dimmer is generally defined as the phase angle of a voltage waveform at which the TRIAC dimmer turns on. Thus, in the embodiment as shown in FIG. 2, the TRIAC dimmer 12 turns on when the phase angle of the waveform 16 is at about ninety degrees (i.e., zero-crossing point 1), and turns off when the phase angle of the waveform 16 is at about one hundred and eighty degrees (i.e., zero-crossing point 2). The TRIAC dimmer 12 turns back on when the phase angle of the waveform 16 is at about two hundred and seventy degrees (i.e., zero-crossing point 3), and turns off when the phase angle of the waveform 16 is at about three hundred and sixty degrees (i.e., zero-crossing point 4).

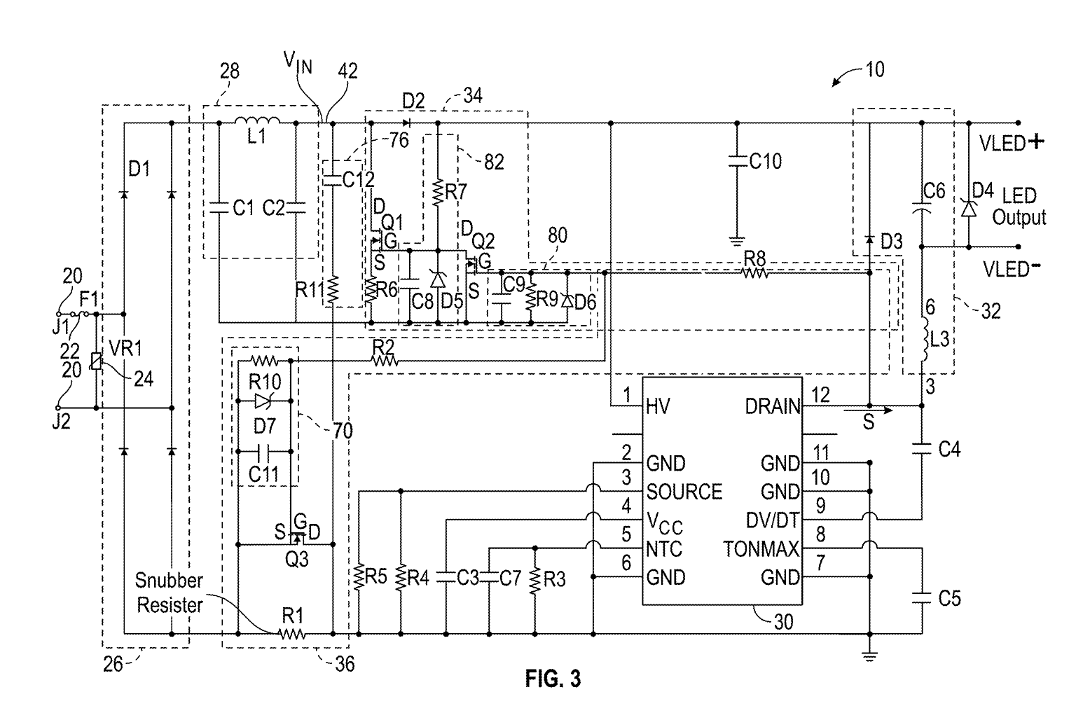

Turning back to FIG. 1, the dimmer circuit 10 may include a pair of power input lines 20 for connection to the TRIAC dimmer 12 and the AC power. The driver circuit 10 may also include a fuse 22, a varistor 24, a rectifier 26, an electromagnetic interference (EMI) filter 28, a controller 30, a buck converter 32, a loading circuit 34, a snubber circuit 36, and one or more LEDs 40. The input lines 20 may be connected to the rectifier 26, which converts incoming AC power to a pulsing DC power. Referring to FIGS. 1 and 3, in one embodiment the rectifier 26 may be a full wave diode bridge rectifier, however those skilled in the art will readily appreciate that any type full wave rectifier may be used as well. The output of the rectifier 26 is connected to the EMI filter 28.

In one non-limiting embodiment the EMI filter 28 may include an inductor L1 as well as two capacitors C1 and C2 in parallel with one another. The output of the EMI filter 28 may be referred to as an input voltage V_{IN}. The input voltage V_{IN} may be provided to the controller 30. The controller 30 may refer to, be part of, or include an electronic circuit, a combinational logic circuit, a field programmable gate array (FPGA), a processor (shared, dedicated, or group) that executes code, other suitable components that provide the described functionality, or a combination of some or all of the above, such as in a system-on-chip. The term module may include memory (shared, dedicated, or group) that stores code executed by the processor. The term code, as used above, may include software, firmware, or microcode, and may refer to programs, routines, functions, classes, or objects.

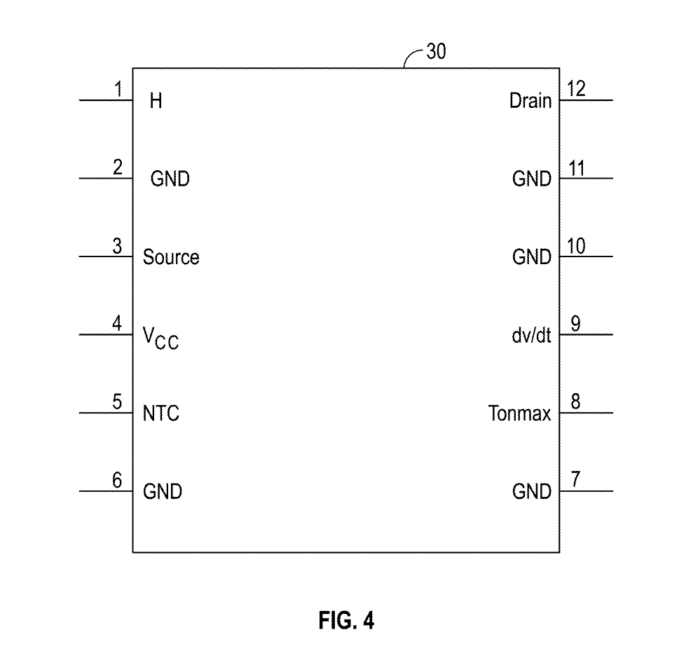

Referring to both FIGS. 3 and 4, one commercially available example of the controller 30 is integrated circuit (IC) model number SSL21082 which is commonly used for LED dimming control, and is available from NXP B.V., of Eindhoven, the Netherlands. The controller 50 may include twelve pins or input/outputs. Specifically, pin 1 is high voltage, pin 2 is ground, pin 3 is source, pin 4 is power supply (V_{CC}), pin 5 is temperature protection input, pin 6 is ground, pin 7 is ground, pin 8 is on-time modulation input, pin 9 is dV/dT or change in voltage, pin 10 is ground, pin 11 is ground, and pin 12 is an internal switch. As seen in FIG. 3, an energy storage or EMI capacitor C10 may be connected to the high voltage pin 1 of the controller 30. The source pin 3 is connected to resistors R3 and R4 that are in parallel with one another. The power supply pin 4 is connected to C3. The temperature protection input pin 5 is connected to capacitor C7 and resistor R3 in series. The on-time modulation input pin 8 is connected to capacitor 5. The change in voltage pin 9 is connected to the buck converter 32 through capacitor C4.

An input line 42 from the EMI filter 26 is connected to and delivers the input voltage V_{IN} to high voltage pin 1 through diode D2. The input voltage V_{IN} is sufficient to activate or turn on the controller 30. Once the controller 30 is activated, a binary (on/off) or switching signal S may be sent though the external switch pin 12. The switching signal S may be sent to the buck converter 32, as well as to both the loading circuit 34 and the snubber circuit 36. In the embodiment as shown in FIG. 3, the buck circuit 44 may include an inductor L3, an electrolytic capacitor C6, and a buck diode D3. The buck converter 32 may be used to provide current to the LED 40 (shown in FIG. 1). A zener diode D4 may be placed in parallel with the buck converter 32 in order to provide over-voltage protection to the LED 40 (FIG. 1).

The switching signal S from the internal switch pin 12 of the controller 30 may be sent to the snubber circuit 36 through resistors R1 and R2. In the embodiment as shown in FIG. 3, the snubber circuit 36 may include gate drive circuitry 70, a switching element Q3, and a snubber resistor R1. The gate drive circuitry 70 may include a resistor R10, a zener diode D7, and a capacitor C11. The switching element Q3 may be selectively activated based on the switching signal S. Specifically, the gate drive circuitry 70 may be used to determine a time delay of the switching signal S from the internal switch pin 12 of the controller 30 before the switching signal S is sent to a gate G of the switching element Q3. The time delay may be used to determine on and off switching times of the switching element Q3.

In the exemplary embodiment as shown in FIG. 3, the switching element Q3 is a metal-oxide-semiconductor field-effect transistor (MOSFET), however it is to be understood that other types of switching elements may be used as well. When the switching element Q3 is activated, the snubber resistor R1 is not supplied voltage and is not part of the dimming circuit 10. Likewise, when the switching element Q3 is not activated, then the snubber resistor R1 is supplied voltage, and therefore is part of the dimming circuit 10. Referring to both FIGS. 2 and 3, since the switching signal S is aligned with the voltage that is sent to the buck converter 32, the snubber resistor R1 is only part of the dimming circuit 10 when the TRIAC 12 is triggered on. In other words, as seen in FIG. 2, the snubber resistor R1 is only activated if the waveform 16 from the TRIAC dimmer 12 is turned on and either above or below zero-crossing (i.e., at the zero crossing point 1 and zero crossing point 3).

Referring to FIGS. 1-3, the snubber resistor R1 is activated by the switching element Q3 when the switching signal S is on in order to reduce or substantially eliminate circuit resonance, which in turn decreases or substantially eliminates any flickering in the LEDs 40. The snubber resistor R1 is deactivated by the switching element Q3 when the switching signal S from the controller 30 is off in order to enhance or improve the overall efficiency of the dimming circuit 10. In additional to the snubber resistor R1, the dimming circuit 10 may also include a second snubber circuit 76, which includes a capacitor C12 and a resistor R11 that are connected in series with one another. The second snubber circuit 76 is an RC type snubber circuit. The second snubber circuit 76 may be connected in parallel with the EMI filter 28. Unlike the snubber resistor R1, the second snubber circuit 76 remains part of the dimming circuit 10 continuously during operation of the TRIAC 12.

The switching signal S from the internal switch pin 12 of the controller 30 may be sent to the loading circuit 34 through the resistor R8. In the embodiment as shown in FIG. 3, the loading circuit 34 may include gate drive circuitry 80, an inverting switching element Q2, gate drive circuitry 82, a switching element Q3, and a resistor R6 that is arranged in series with the switching element Q3. The gate drive circuitry 80 may include a zener diode D6, a resistor R9, and a capacitor C9. The gate drive circuitry 80 may be used to condition the switching signal S from the internal switch pin 12 of the controller 30 before the switching signal S is sent to a gate G of the inverting switching element Q2. The gate drive circuitry 80 may also be used to determine on and off switching times of the inverting switching element Q2.

The inverting switching element Q2 may be used to invert the switching signal S sent from the internal switch pin 12 of the controller 30, before the switching signal S is sent to the switching element Q1. Thus, when the switching element Q1 is on or activated, the switching element Q3 is off or deactivated. Likewise, when the switching element Q1 is off or deactivated, the switching element Q3 is on or activated.

The gate drive circuitry 82 may include a resistor R7, a zener diode D5, and a capacitor C8. The gate drive circuitry 82 may be used to condition the switching signal S from the inverting switching element Q2 before the switching signal S is sent to a gate G of the switching element Q1. The gate drive circuitry 82 may also be used to determine on and off switching times of the inverting switching element Q1.

The switching element Q1 may be used to selectively supply an additional or minimum loading current back to the TRIAC 12 when turned on or activated. The dimmer circuit 10 may already provide some loading current to the TRIAC dimmer 12. However the switching element Q1 is used to provide the additional or minimum loading current back to the TRIAC dimmer 12. The additional loading current may be used to maintain the firing angle (shown in FIG. 2) of the TRIAC dimmer 12, which is described in greater detail below.

Referring to FIGS. 2-3, the loading circuit 34 provides the minimum loading current to the TRIAC dimmer 12 if the switching element Q3 is turned on or activated. The minimum loading current may be used to substantially dissipate a leakage current flowing through the TRIAC dimmer 12 when the TRIAC dimmer 12 is off. TRIAC dimmers are not ideal devices. This means that even if the TRIAC dimmer 12 is off, leakage current may still flow through. If left unchecked, the leakage current may interact with the dimmer circuit 10, thereby causing LED flickering. Specifically, if left unchecked the leakage current from the TRIAC dimmer 12 may interact with the components in the EMI filter (e.g., the capacitors C1 and C2 and inductor L1), the second snubber circuit 76 (e.g., capacitor C12 and resistor R11), and the EMI capacitor 10, thereby creating resonance. The resonance may create unwanted oscillations in the dimming circuit 10, which contain stray inductances and/or capacitances. These oscillations may create LED flickering. Dissipating the leakage current in the TRIAC dimmer 12 reduces or substantially eliminates the instances of LED flickering.

Continuing to refer to FIGS. 2-3, when the TRIAC dimmer 12 is off (i.e., between 0 and the zero crossing point 1, and between zero crossing point 2 and zero crossing point 3), the minimum loading current is provided by the dimmer circuit 10. In one embodiment, the minimum loading current from the switching element Q1 is determined by the following equation:

$$Minimum loading current = \frac{voltage of D 5 - Gate to source voltage ( {V}_{GS} ) of Q 1}{resistance of resistor R 6}$$

A source S of the switching element Q1 is connected to resistor R6. Thus, the minimum loading current flows from the resistor R6 and back through to the TRIAC dimmer 12. Therefore, if the switching signal S sent by the controller 30 is on, the loading circuit 34 may provide the minimum loading current back to the TRIAC 12.

Referring generally to FIGS. 1-4, the dimmer circuit 10 may be used to provide a relatively cost-effective and simple approach for dimming an LED. Specifically, the disclosed dimmer circuit 10 includes a simpler design using fewer electrical components when compared to some other types of dimming circuits currently available. In addition to a relatively cost-effective design, the disclosed dimmer circuit 10 may also generally prevent flickering of one or more LEDs.

While the forms of apparatus and methods herein described constitute preferred embodiments of this invention, it is to be understood that the invention is not limited to these precise forms of apparatus and methods, and the changes may be made therein without departing from the scope of the invention.

1. A dimmer circuit for at least one LED that is controlled by a TRIAC dimmer, wherein a leakage current flows through the TRIAC dimmer if the TRIAC dimmer is off, comprising:
inputs for receiving a source of incoming AC power;
a rectifier for receiving the source of incoming AC power, the rectifier producing a DC voltage;
a controller for receiving the DC voltage from the rectifier and providing a switching signal;
a first circuit for receiving the switching signal from the controller, the first circuit including a first switching element that is selectively activated based on the switching signal;
a loading circuit for receiving the switching signal from the controller, wherein the loading circuit includes a second switching element that is activated if the first switching element is deactivated, the loading circuit selectively providing a minimum loading current that substantially dissipates the leakage current flowing through the TRIAC dimmer if the second switching element is activated, and wherein the loading circuit further includes a third switching element that inverts the switching signal before being sent to the second switching element.

2. (canceled)

3. The dimmer circuit as recited in claim 1, wherein the first circuit is a snubber circuit including a snubber resistor.

4. The dimmer circuit as recited in claim 3, wherein the snubber resistor is part of the dimming circuit if the first switching element is deactivated.

5. The dimmer circuit as recited in claim 3, wherein the snubber resistor is activated if the TRIAC dimmer is on.

6. The dimmer circuit as recited in claim 1, wherein the first switching element and the second switching element are metal-oxide-semiconductor field-effect transistors (MOSFETs).

7. The dimmer circuit as recited in claim 1, comprising a buck converter that provides current to the LED.

8. The dimmer circuit as recited in claim 7, wherein the buck converter receives the switching signal from the controller.

9. The dimmer circuit as recited in claim 1, wherein the loading circuit comprises a resistor, a zener diode, and a capacitor that define gate drive circuitry that conditions the switching signal before being sent to the second switching element.

10. The dimmer circuit as recited in claim 9, wherein the loading circuit comprises a second resistor that is arranged in series with the second switching element.

11. The dimmer circuit as recited in claim 10, wherein the minimum loading current is determined by the following equation:
$$\frac{\begin{matrix}a voltage of the zener diode - \\ a gate to source voltage ( {V}_{GS} ) of the second switching element\end{matrix}}{a resistance of the second resistor} .$$

12. The dimmer circuit as recited in claim 1, wherein the LED is an organic LED (OLED).

13. A dimmer circuit for at least one LED that is controlled by a TRIAC dimmer, wherein a leakage current flows through the TRIAC dimmer if the TRIAC dimmer is off, comprising:
inputs for receiving a source of incoming AC power;
a rectifier for receiving the source of incoming AC power, the rectifier producing a DC voltage;
a controller for receiving the DC voltage from the rectifier and providing a switching signal;
a snubber circuit for receiving the switching signal from the controller, the snubber circuit including a first switching element and a snubber resistor, the first switching element selectively activated based on the switching signal; and
a loading circuit for receiving the switching signal from the controller, wherein the loading circuit comprises:
a second switching element that is activated if the first switching element is deactivated; and
a third switching element that inverts the switching signal before being sent to the second switching element,
wherein the loading circuit selectively provides a minimum loading current that substantially dissipates the leakage current flowing through the TRIAC dimmer if the second switching element is activated.

14. The dimmer circuit as recited in claim 13, wherein the snubber resistor is part of the dimming circuit if the first switching element is deactivated.

15. The dimmer circuit as recited in claim 13, wherein the snubber resistor is activated if the TRIAC dimmer is on.

16. The dimmer circuit as recited in claim 13, wherein the first switching element, the second switching element, and the third switching element are metal-oxide-semiconductor field-effect transistors (MOSFETs).

17. The dimmer circuit as recited in claim 13, comprising a buck converter that provides current to the LED.

18. The dimmer circuit as recited in claim 13, wherein the loading circuit comprises a resistor, a zener diode, and a capacitor that define gate drive circuitry that conditions the switching signal before being sent to the second switching element.

19. The dimmer circuit as recited in claim 18, wherein the loading circuit comprises a second resistor that is arranged in series with the second switching element.

20. The dimmer circuit as recited in claim 19, wherein the minimum loading current is determined by the following equation:
$$\frac{\begin{matrix}a voltage of the zener diode - \\ a gate to source voltage ( {V}_{GS} ) of the second switching element\end{matrix}}{a resistance of the second resistor} .$$

21. A dimmer circuit for at least one LED that is controlled by a TRIAC dimmer, wherein a leakage current flows through the TRIAC dimmer if the TRIAC dimmer is off, comprising:
inputs for receiving a source of incoming AC power;
a rectifier for receiving the source of incoming AC power, the rectifier producing a DC voltage;
a controller for receiving the DC voltage from the rectifier and providing a switching signal;
a first circuit for receiving the switching signal from the controller, the first circuit including a first switching element that is selectively activated based on the switching signal, wherein the first circuit is a snubber circuit including a snubber resistor; and
a loading circuit for receiving the switching signal from the controller, wherein the loading circuit includes a second switching element that is activated if the first switching element is deactivated, the loading circuit selectively provides a minimum loading current that substantially dissipates the leakage current flowing through the TRIAC dimmer if the second switching element is activated.

22. The dimmer circuit as recited in claim 21, wherein the snubber resistor is part of the dimming circuit if the first switching element is deactivated.

23. The dimmer circuit as recited in claim 21, wherein the snubber resistor is activated if the TRIAC dimmer is on.

24. A dimmer circuit for at least one LED that is controlled by a TRIAC dimmer, wherein a leakage current flows through the TRIAC dimmer if the TRIAC dimmer is off, comprising:
inputs for receiving a source of incoming AC power;
a rectifier for receiving the source of incoming AC power, the rectifier producing a DC voltage;
a controller for receiving the DC voltage from the rectifier and providing a switching signal;
a first circuit for receiving the switching signal from the controller, the first circuit including a first switching element that is selectively activated based on the switching signal;
a loading circuit for receiving the switching signal from the controller, wherein the loading circuit includes a second switching element that is activated if the first switching element is deactivated, the loading circuit selectively provides a minimum loading current that substantially dissipates the leakage current flowing through the TRIAC dimmer if the second switching element is activated; and
a buck converter that provides current to the LED, wherein the buck converter receives the switching signal from the controller.

25. A dimmer circuit for at least one LED that is controlled by a TRIAC dimmer, wherein a leakage current flows through the TRIAC dimmer if the TRIAC dimmer is off, comprising:
inputs for receiving a source of incoming AC power;
a rectifier for receiving the source of incoming AC power, the rectifier producing a DC voltage;
a controller for receiving the DC voltage from the rectifier and providing a switching signal;
a first circuit for receiving the switching signal from the controller, the first circuit including a first switching element that is selectively activated based on the switching signal;
a loading circuit for receiving the switching signal from the controller, wherein the loading circuit includes a second switching element that is activated if the first switching element is deactivated, the loading circuit selectively provides a minimum loading current that substantially dissipates the leakage current flowing through the TRIAC dimmer if the second switching element is activated, and wherein the loading circuit comprises a resistor, a zener diode, and a capacitor that define gate drive circuitry that conditions the switching signal before being sent to the second switching element.

26. The dimmer circuit as recited in claim 25, wherein the loading circuit comprises a second resistor that is arranged in series with the second switching element.

27. The dimmer circuit as recited in claim 26, wherein the minimum loading current is determined by the following equation:
$$\frac{\begin{matrix}a voltage of the zener diode - \\ a gate to source voltage ( {V}_{GS} ) of the second switching element\end{matrix}}{a resistance of the second resistor} .$$
